(19) United States
(12) Patent Application Publication
(10) Pub. No.: US 2022/0051086 A1
(43) Pub. Date: Feb. 17, 2022

(54) VECTOR ACCELERATOR FOR ARTIFICIAL INTELLIGENCE AND MACHINE LEARNING

(71) Applicant: ALIBABA GROUP HOLDING LIMITED, George Town (KY)

(72) Inventors: Fei XUE, San Mateo, CA (US); Wei HAN, San Mateo, CA (US); Yuhao WANG, San Mateo, CA (US); Fei SUN, San Mateo, CA (US); Lide DUAN, San Mateo, CA (US); Shuangchen LI, San Mateo, CA (US); Dimin NIU, San Mateo, CA (US); Tianchan GUAN, Shanghai (CN); Linyong HUANG, Hangzhou (CN); Zhaoyang DU, Hangzhou (CN); Hongzhong ZHENG, San Mateo, CA (US)

(21) Appl. No.: 17/443,208

(22) Filed: Jul. 22, 2021

Related U.S. Application Data
(60) Provisional application No. 63/066,723, filed on Aug. 17, 2020.

(51) Int. Cl. G06N 3/063

(52) U.S. Cl. CPC G06N 3/063

(57) ABSTRACT

The present disclosure provides an accelerator for processing a vector or matrix operation. The accelerator comprises a vector processing unit comprising a plurality of computation units having circuitry configured to process a vector operation in parallel; a matrix multiplication unit comprising a first matrix multiplication operator, a second matrix multiplication operator, and an accumulator, the first matrix multiplication operator and the second matrix multiplication operator having circuitry configured to process a matrix operation and the accumulator having circuitry configured to accumulate output results of the first matrix multiplication operator and the second matrix multiplication operator; and a memory storing input data for the vector operation or the matrix operation and being configured to communicate with the vector processing unit and the matrix multiplication unit.

### CROSS-REFERENCE TO RELATED APPLICATIONS

The disclosure claims the benefits of priority to U.S. Provisional Application No. 63/066,723, filed Aug. 17, 2020, which is incorporated herein by reference in its entirety.

### TECHNICAL FIELD

The present disclosure generally relates to an accelerator for artificial intelligence (AI) and machine learning (ML), and more particularly to an accelerator configured to support processing neural networks requiring a large amount of data such as vector or matrix operations.

### BACKGROUND

Artificial intelligence (AI) and machine learning (ML) have been widely used in various domains. Neural networks applied on artificial intelligence or machine learning usually require processing of a large amount of data. However, conventional central processing unit (CPU) or graphics processing unit (GPU) architectures are not specifically designed for processing large data and are not optimized for processing neural networks including vector or matrix operations, which usually require a large amount of data. It is important to improve performance of processing neural networks consuming a large amount of data to increase overall execution performance.

### SUMMARY OF THE DISCLOSURE

Embodiments of the present disclosure provide an accelerator for processing a vector or matrix operation. The accelerator comprises a vector processing unit comprising a plurality of computation units having circuitry configured to process a vector operation in parallel; a matrix multiplication unit comprising a first matrix multiplication operator, a second matrix multiplication operator, and an accumulator, the first matrix multiplication operator and the second matrix multiplication operator having circuitry configured to process a matrix operation and the accumulator having circuitry configured to accumulate output results of the first matrix multiplication operator and the second matrix multiplication operator; and a memory storing input data for the vector operation or the matrix operation and being configured to communicate with the vector processing unit and the matrix multiplication unit.

Embodiments of the present disclosure provide a method for processing a vector or matrix operation on an accelerator comprising a vector processing unit comprising a plurality of computation units having circuitry configured to process a vector operation in parallel, a matrix multiplication unit comprising a matrix multiplication operator having circuitry configured to process a matrix operation, and a memory storing input data for the vector operation or the matrix operation and comprising a plurality of rows, each row being configured to store data that can be processed concurrently by the plurality of computation units or by the matrix multiplication operator. The method comprises partitioning input data into multiple pieces of data and storing each piece of data in a corresponding row of the plurality of rows; providing a first piece of data stored in a first row of the plurality of rows to the vector processing unit or the matrix multiplication unit; and performing a vector operation or a matrix operation on the first piece of data concurrently by the plurality of computation units or by the matrix multiplication operator.

Embodiments of the present disclosure provide a device comprising a host unit; and an accelerator communicatively coupled to the host unit. The accelerator comprises a vector processing unit comprising a plurality of computation units having circuitry configured to process a vector operation in parallel; a matrix multiplication unit comprising a first matrix multiplication operator, a second matrix multiplication operator, and an accumulator, the first matrix multiplication operator and the second matrix multiplication operator having circuitry configured to process a matrix operation and the accumulator having circuitry configured to accumulate output results of the first matrix multiplication operator and the second matrix multiplication operator; and a memory storing input data for the vector operation or the matrix operation and being configured to communicate with the vector processing unit and the matrix multiplication unit.

Additional features and advantages of the disclosed embodiments will be set forth in part in the following description, and in part will be apparent from the description, or may be learned by practice of the embodiments. The features and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1A illustrates an exemplary neural network accelerator architecture, consistent with some embodiments of the present disclosure.

FIG. 1B illustrates an exemplary neural network accelerator core architecture comprising vector accelerating unit, consistent with some embodiments of the present disclosure.

FIG. 1C illustrates a schematic diagram of an exemplary cloud system incorporating a neural network accelerator, consistent with some embodiments of the present disclosure.

FIG. 2 illustrates an exemplary memory structure and memory layout, consistent with some embodiments of the present disclosure.

FIG. 3 illustrates an exemplary vector processing unit (VPU) architecture, consistent with some embodiments of the present disclosure.

FIG. 4 illustrates an exemplary general matrix multiplication unit (GEMM) architecture, consistent with some embodiments of the present disclosure.

FIG. 5A illustrates an example matrix multiplication operation, consistent with some embodiments of the present disclosure.

FIG. 5B illustrates an example data flow in matrix multiplication unit for processing a matrix multiplication operation of FIG. 5A, consistent with some embodiments of the present disclosure.

FIG. 6 illustrates an exemplary flow diagram for processing a vector operation or matrix operation, consistent with some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

Artificial intelligence (AI) and machine learning (ML) have been widely used in various domains. Neural networks applied on artificial intelligence or machine learning usually require processing of a large amount of data. However, conventional central processing unit (CPU) or graphics processing unit (GPU) architectures are not specifically designed for processing large data and are not optimized for processing neural networks including vector or matrix operations, which usually require a large amount of data. It is important to improve performance of processing neural networks consuming a large amount of data to increase overall execution performance.

According to some embodiments of the present disclosure, an accelerator system that can support processing neural networks consuming a large amount of data. According to some embodiments of the present disclosure, performance for processing various vector or matrix operations including, but not limited to, matrix multiplication operation, matrix element-wise operation, matrix activation operations, vector-vector operation, vector-scalar operation, etc. can be improved. According to some embodiments of the present disclosure, an accelerator system having tightly pipelined intra-function units and inter-function units that can optimize performance in processing neural networks is provided.

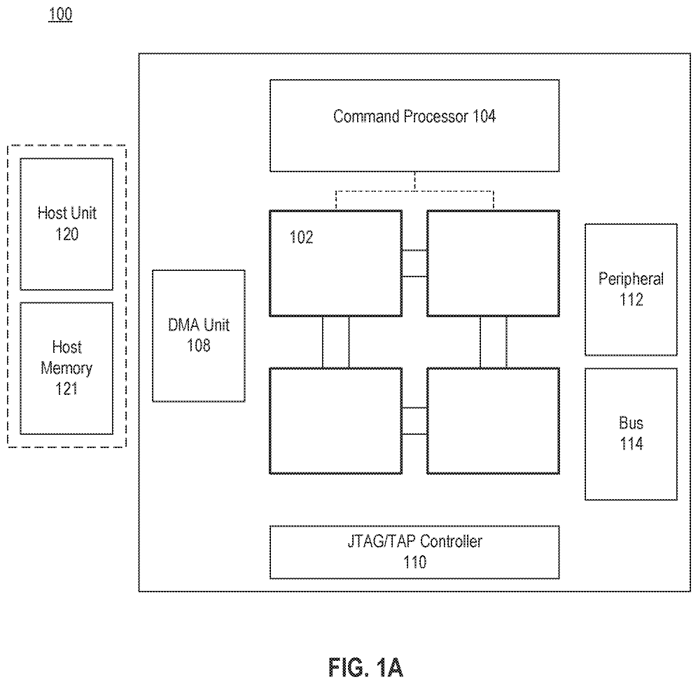

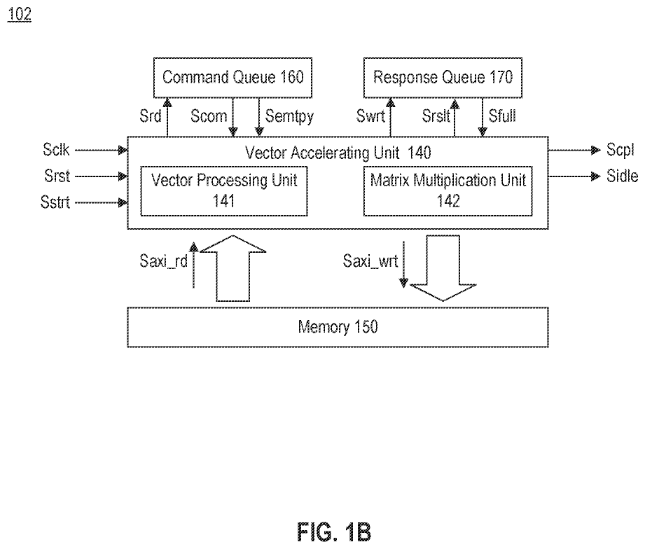

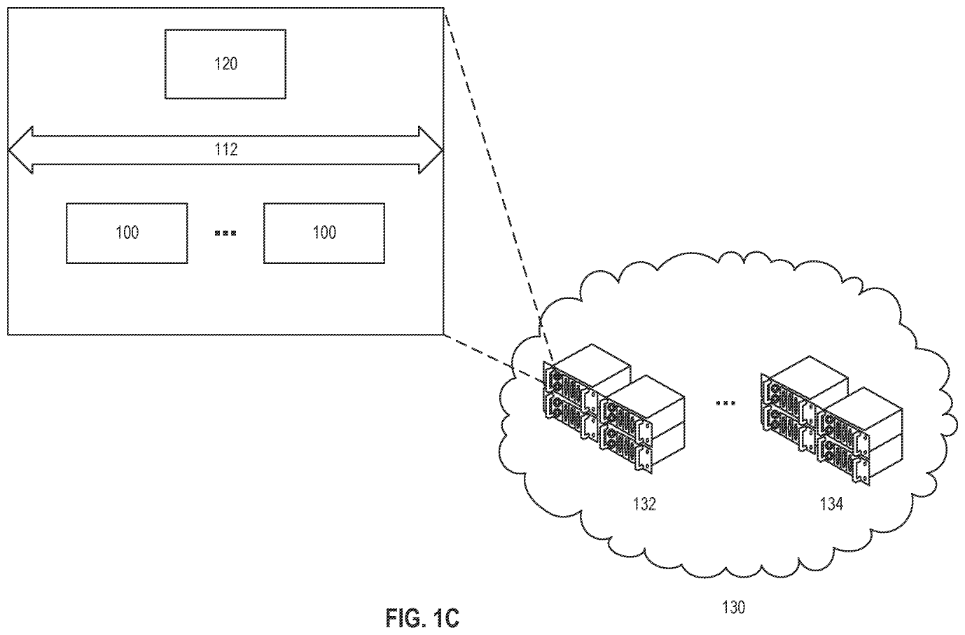

FIG. 1A illustrates an exemplary neural network accelerator architecture, consistent with some embodiments of the present disclosure. In the context of this disclosure, a neural network accelerator may also be referred to as a machine learning accelerator or deep learning accelerator. In some embodiments, accelerator 100 may be referred to as a neural network processing unit (NPU) 100. As shown in FIG. 1A, accelerator 100 can include a plurality of cores 102, a command processor 104, a direct memory access (DMA) unit 108, a Joint Test Action Group (JTAG)/Test Access End (TAP) controller 110, a peripheral interface 112, a bus 114, and the like.

It is appreciated that, cores 102 can perform algorithmic operations based on communicated data. Cores 102 can include one or more processing elements that may include single instruction, multiple data (SIMD) architecture including one or more processing units configured to perform one or more operations (e.g., multiplication, addition, multiply-accumulate, etc.) based on commands received from command processor 104. To perform the operation on the communicated data packets, cores 102 can include one or more processing elements for processing information in the data packets. Each processing element may comprise any number of processing units. According to some embodiments of the present disclosure, accelerator 100 may include a plurality of cores 102, e.g., four cores. In some embodiments, the plurality of cores 102 can be communicatively coupled with each other. For example, the plurality of cores 102 can be connected with a single directional ring bus, which supports efficient pipelining for large neural network models. The architecture of cores 102 will be explained in detail with respect to FIG. 1B.

Command processor 104 can interact with a host unit 120 and pass pertinent commands and data to corresponding core 102. In some embodiments, command processor 104 can interact with host unit 120 under the supervision of kernel mode driver (KMD). In some embodiments, command processor 104 can modify the pertinent commands to each core 102, so that cores 102 can work in parallel as much as possible. The modified commands can be stored in an instruction buffer. In some embodiments, command processor 104 can be configured to coordinate one or more cores 102 for parallel execution.

DMA unit 108 can assist with transferring data between host memory 121 and accelerator 100. For example, DMA unit 108 can assist with loading data or instructions from host memory 121 into local memory of cores 102. DMA unit 108 can also assist with transferring data between multiple accelerators. DMA unit 108 can allow off-chip devices to access both on-chip and off-chip memory without causing a host CPU interrupt. In addition, DMA unit 108 can assist with transferring data between components of accelerator 100. For example, DMA unit 108 can assist with transferring data between multiple cores 102 or within each core. Thus, DMA unit 108 can also generate memory addresses and initiate memory read or write cycles. DMA unit 108 can also contain several hardware registers that can be written and read by the one or more processors, including a memory address register, a byte-count register, one or more control registers, and other types of registers. These registers can specify some combination of the source, the destination, the direction of transfer (reading from the input/output (I/O) device or writing to the I/O device), the size of the transfer unit, or the number of bytes to transfer in one burst. It is appreciated that accelerator 100 can include a second DMA unit, which can be used to transfer data between other accelerator architectures to allow multiple accelerator architectures to communicate directly without involving the host CPU.

JTAG/TAP controller 110 can specify a dedicated debug port implementing a serial communications interface (e.g., a JTAG interface) for low-overhead access to the accelerator without requiring direct external access to the system address and data buses. JTAG/TAP controller 110 can also have on-chip test access interface (e.g., a TAP interface) that implements a protocol to access a set of test registers that present chip logic levels and device capabilities of various parts.

Peripheral interface 112 (such as a PCIe interface), if present, serves as an (and typically the) inter-chip bus, providing communication between the accelerator and other devices.

Bus 114 (such as a I²C bus) includes both intra-chip bus and inter-chip buses. The intra-chip bus connects all internal components to one another as called for by the system architecture. While not all components are connected to every other component, all components do have some connection to other components they need to communicate with. The inter-chip bus connects the accelerator with other devices, such as the off-chip memory or peripherals. For example, bus 114 can provide high speed communication across cores and can also connect cores 102 with other units, such as the off-chip memory or peripherals. Typically, if there is a peripheral interface 112 (e.g., the inter-chip bus), bus 114 is solely concerned with intra-chip buses, though in some implementations it could still be concerned with specialized inter-bus communications.

Accelerator 100 can also communicate with host unit 120. Host unit 120 can be one or more processing unit (e.g., an X86 central processing unit). As shown in FIG. 1A, host unit 120 may be associated with host memory 121. In some embodiments, host memory 121 may be an integral memory or an external memory associated with host unit 120. In some embodiments, host memory 121 may comprise a host disk, which is an external memory configured to provide additional memory for host unit 120. Host memory 121 can be a double data rate synchronous dynamic random-access memory (e.g., DDR SDRAM) or the like. Host memory 121 can be configured to store a large amount of data with slower access speed, compared to the on-chip memory integrated within an accelerator chip, acting as a higher-level cache. The data stored in host memory 121 may be transferred to accelerator 100 to be used for executing neural network models.

In some embodiments, a host system having host unit 120 and host memory 121 can comprise a compiler (not shown). The compiler is a program or computer software that transforms computer codes written in one programming language into instructions for accelerator 100 to create an executable program. In machine learning applications, a compiler can perform a variety of operations, for example, pre-processing, lexical analysis, parsing, semantic analysis, conversion of input programs to an intermediate representation, initialization of a neural network, code optimization, and code generation, or combinations thereof. For example, the compiler can compile a neural network to generate static parameters, e.g., connections among neurons and weights of the neurons.

In some embodiments, host system including the compiler may push one or more commands to accelerator 100. As discussed above, these commands can be further processed by command processor 104 of accelerator 100, temporarily stored in an instruction buffer of accelerator 100, and distributed to corresponding one or more cores (e.g., cores 102 in FIG. 1A) or processing elements. Some of the commands may instruct a DMA unit (e.g., DMA unit 108 of FIG. 1A) to load instructions and data from host memory (e.g., host memory 121 of FIG. 1A) into accelerator 100. The loaded instructions may then be distributed to each core (e.g., core 102 of FIG. 1A) assigned with the corresponding task, and the one or more cores may process these instructions.

It is appreciated that the first few instructions received by cores 102 may instruct the cores 102 to load/store data from host memory 121 into one or more local memories of the cores (e.g., memory 150 of FIG. 1B). Each core 102 may then initiate the instruction pipeline, which involves fetching the instruction from the instruction buffer, decoding the instruction (e.g., via a DMA unit 108 of FIG. 1A), generating local memory addresses (e.g., corresponding to an operand), reading the source data, executing or loading/storing operations, and then writing back results.

According to some embodiments, accelerator 100 can further include a global memory (not shown) having memory blocks (e.g., 4 blocks of 8 GB second generation of high bandwidth memory (HBM2)) to serve as main memory. In some embodiments, the global memory can store instructions and data from host memory 121 via DMA unit 108. The instructions can then be distributed to an instruction buffer of each core assigned with the corresponding task, and the core can process these instructions accordingly.

In some embodiments, accelerator 100 can further include memory controller (not shown) configured to manage reading and writing of data to and from a specific memory block (e.g., HBM2) within global memory. For example, memory controller can manage read/write data coming from core of another accelerator (e.g., from DMA unit 108 or a DMA unit corresponding to another accelerator) or from core 102 (e.g., from a local memory in core 102). It is appreciated that more than one memory controller can be provided in accelerator 100. For example, there can be one memory controller for each memory block (e.g., HBM2) within global memory.

Memory controller can generate memory addresses and initiate memory read or write cycles. Memory controller can contain several hardware registers that can be written and read by the one or more processors. The registers can include a memory address register, a byte-count register, one or more control registers, and other types of registers. These registers can specify some combination of the source, the destination, the direction of the transfer (reading from the input/output (I/O) device or writing to the I/O device), the size of the transfer unit, the number of bytes to transfer in one burst, or other typical features of memory controllers.

While accelerator 100 of FIG. 1A can be used for convolutional neural networks (CNNs) in some embodiments of the present disclosure, it is appreciated that accelerator 100 of FIG. 1A can be utilized in various neural networks, such as deep neural networks (DNNs), recurrent neural networks (RNNs), or the like. In addition, some embodiments can be configured for various processing architectures, such as neural network processing units (NPUs), graphics processing units (GPUs), field programmable gate arrays (FPGAs), tensor processing units (TPUs), application-specific integrated circuits (ASICs), any other types of heterogeneous accelerator processing units (HAPUs), or the like.

FIG. 1B illustrates an exemplary neural network accelerator core architecture comprising vector accelerating unit, consistent with some embodiments of the present disclosure. As shown in FIG. 1B, core 102 can comprise a vector accelerating unit 140, a memory 150, command queue 160, and response queue 170. As shown in FIG. 1B, vector accelerating unit 140 can comprise a vector processing unit 141 and a matrix multiplication unit 142. According to some embodiments of the present disclosure, vector processing unit 141 and matrix multiplication unit 142 are tightly pipelined. For example, after vector processing unit 141 processes a small block of data and stores result data back to a shared memory, matrix multiplication unit 142 can start processing an operation based on the result data by reading out the result data from the shared memory, and vice versa.

According to some embodiments of the present disclosure, vector processing unit 141 can perform vector operations including, but not limited to, vector-vector operations, N number of vector operations, vector-scalar operations, vector-immediate number operations, vector elementwise operations, padding or vector reshaping operations, etc. According to some embodiments of the present disclosure, matrix multiplication unit 142 can perform matrix multiplication operations, matrix elementwise operations, matrix ReLU (rectified linear unit) activation operations, etc.

As shown in FIG. 1B, control signals including, but not limited to, clock signal Sclk, reset signal Srst, start signal Sstrt, etc. can be provided to vector accelerating unit 140, consistent with some embodiments of the present disclosure. In some embodiments, vector accelerating unit 140 can generate output signals including, but not limited to, completion signal Scpl, idle signal Sidle, etc. In some embodiments, such control signals can be used when integrating a core of FIG. 1B with other systems or cores. For example, control signals can be used to communicate with a host system (e.g., host unit 120 of FIG. 1A).

In some embodiments, command queue 160 can provide command(s) to vector accelerating unit 140. According to some embodiments, vector accelerating unit 140 can send a read signal Srd to command queue 160 to request command(s) from command queue 160. In response, command queue 160 can send a command signal Scom accompanying a command(s) to vector accelerating unit 160, consistent with some embodiments of the present disclosure. In some embodiments, command queue 160 can send an empty signal Sempty to notify vector accelerating unit 140 that there are no pending commands in command queue 160. In some embodiments, after completing or partially completing execution of a certain operation, vector accelerating unit 140 can send a write signal Swrt to notify response queue 170 that there is an execution result to come in. In some embodiments, vector accelerating unit 140 can send a result signal Srslt accompanying an execution result to response queues 170, consistent with some embodiments of the present disclosure. The execution result may comprise completion, success, failure, etc. In some embodiments, response queue 170 can send a full signal Sfull to notify vector accelerating unit 140 that there is no space left in the queue. In some embodiments, vector accelerating unit 140 can wait for response queue 170 to be emptied before sending an execution result to response queue 170.

As shown in FIG. 1B, memory 150 can be shared by vector processing unit 141 and matrix multiplication unit 142, consistent with some embodiments of the present disclosure. In some embodiments, vector processing unit 141 and matrix multiplication unit 142 can communicate with memory 150 and transfer data to/from memory 150 via interface(s), e.g., AXI interface. For example, vector processing unit 141 and matrix multiplication unit 142 can read data from memory 150 according read signal Saxi-rd and can store data to memory 150 according to write signal Saxi-wrt. In some embodiments, vector processing unit 141 and matrix multiplication unit 142 may not directly communicate each other to exchange data.

FIG. 1C illustrates a schematic diagram of an exemplary cloud system incorporating a neural network accelerator 100, consistent with some embodiments of the present disclosure. As shown in FIG. 1C, cloud system 130 can provide a cloud service with artificial intelligence (AI) capabilities and can include a plurality of computing servers (e.g., 132 and 134). In some embodiments, a computing server 132 can, for example, incorporate a neural network accelerator 100 of FIG. 1A. In some embodiments, accelerator 100 can communicate with host unit 120 via peripheral interface 112. In some embodiments, host unit 120 can send commands to accelerator 100 so that vector accelerating unit 140 can process the commands. Neural network accelerator 100 is shown in FIG. 1A in a simplified manner for simplicity and clarity. With the assistance of neural network accelerator 100, cloud system 130 can provide the extended AI capabilities of image recognition, facial recognition, translations, 3D modeling, and the like. It is appreciated that, neural network accelerator 100 can be deployed to computing devices in other forms. For example, neural network accelerator 100 can also be integrated in a computing device, such as a smart phone, a tablet, and a wearable device.

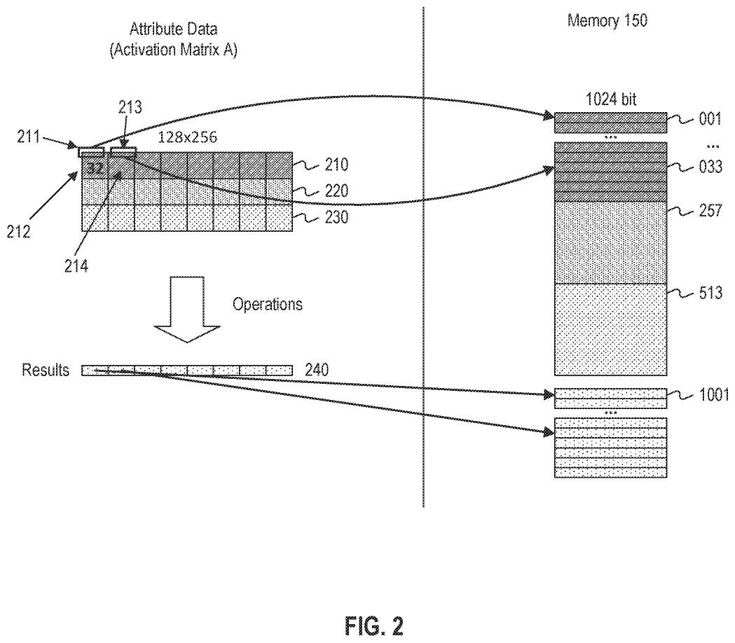

FIG. 2 illustrates an exemplary memory structure and memory layout, consistent with some embodiments of the present disclosure. According to some embodiments of the present disclosure, a memory structure and memory layout illustrated in FIG. 2 can promote pipelining of functions of vector processing unit 141 and matrix multiplication unit 142.

FIG. 2 shows a matrix of attribute data (e.g., activation matrix A) as example input data to be loaded to a memory (e.g., memory 150). For example, a vector operation (e.g., by vector processing unit 141) or matrix operation (e.g., by matrix multiplication unit 142) can be performed on at least part of the attribute data as input data. While an activation matrix A of size 128×256 is illustrated in FIG. 2, it will be appreciated that any matrix size can be applicable. According to some embodiments of the present disclosure, when loading data into memory 150, data is partitioned into smaller pieces and stored in memory 150.

As shown in FIG. 2, memory 150 can be structured to have a plurality of rows, each row can store data that can be processed by vector accelerating unit 140 concurrently. For example, when vector processing unit 141 can process 32 elements concurrently, one row of memory 150 can store 32 elements (i.e., 1024 bits). A row size of memory 150 can change depending on a hardware architecture, a system requirement, etc. In some embodiments, when matrix multiplication unit 142 can process an attribute matrix block, a row of memory 150 can have the same size as the row of the attribute matrix block that can be processed by matrix multiplication unit 142 at once.

In FIG. 2, first block 212 of activation matrix A corresponds to a matrix of size 32×32 and first row 211 of first block 212 corresponds to a matrix (or vector) of size 1×32. Each row of each block can sequentially be loaded to memory 150 from first row 001. For example, first row 211 of first block 212 can be loaded to first row 001 of memory 150, second row (not indicated) of first block 212 can be loaded to second row of memory 150, and similarly third to 32^{nd} rows of first block 212 can be loaded to third to 32^{nd} rows of memory 150. Similarly, rows of a second block 214 next to first block 212 can be loaded from 33^{rd} row of memory 150. For example, first row 213 of second block 214 can be loaded to 33^{rd} row of memory 150. Similarly, after all rows of all blocks in first block row 210 are loaded to memory 150 (e.g., 1^{st} to 256^{th} rows 001 to 256 of memory 150), second block row 220 can be loaded to memory 150 from 257^{th} row of memory 150. Similarly, third block row 230 can be loaded to memory 150 from 513^{th} row of memory 150. As illustrated in FIG. 2, when data is loaded to memory 150, data can be partitioned into smaller pieces and each piece can be loaded to each row of memory 150.

According to some embodiments of the present disclosure, output data can also be stored in memory 150 in a similar way of loading input data into memory 150. In some embodiments, output data 140 can be results of a certain operation (e.g., a vector operation) on attribute data. As shown in FIG. 2, output data can also be broken down into smaller pieces and each piece can be stored in memory 150 from a designated row. According to some embodiments, vector accelerating unit 140 may not generate whole output data (e.g., as indicated with 240) at the same time because a data size that vector accelerating unit 140 can process is limited as discussed above. In some embodiments, vector accelerating unit 140 may generate output data having a unit data size suitable to be stored in one row at a time. Therefore, output data can be stored in memory 150 sequentially row by row. It will be appreciated that output data can refer to intermediate result data that can be used in subsequent operations.

According to some embodiments of the present disclosure, by configuring memory 150 such that data is stored per unit data size that can be processed in vector accelerating unit 140 at a time as shown in FIG. 2, vector or matrix operation execution efficiency can be improved. Further, it will be appreciated that, because output data or intermediate data is stored per unit data size in memory 150, execution efficiency for subsequent operations consuming the output data or intermediate data can also be improved.

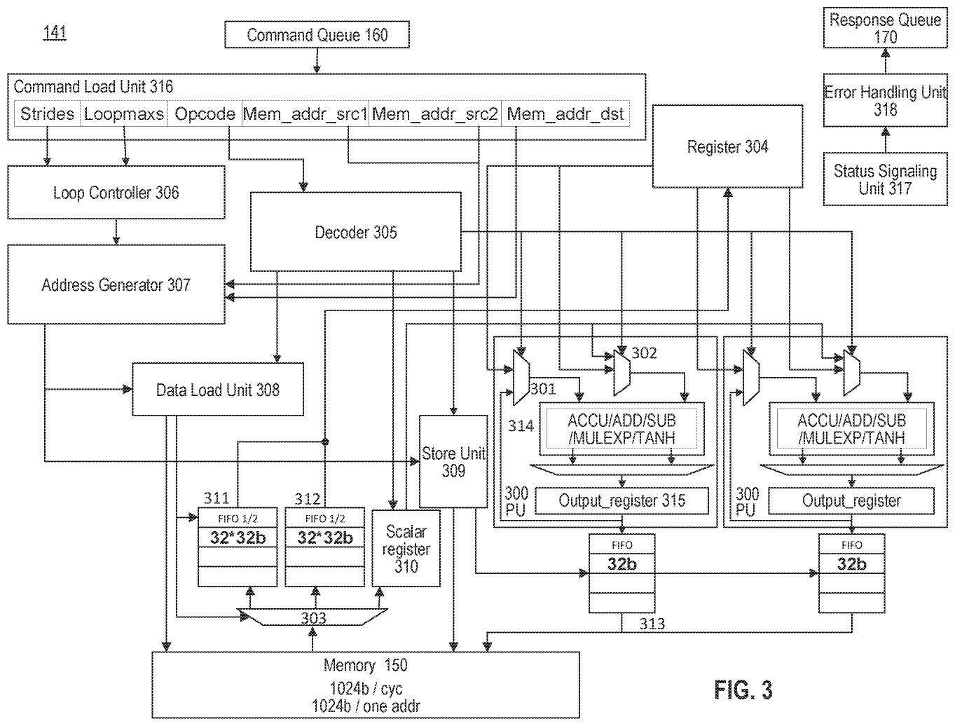

FIG. 3 illustrates an exemplary vector processing unit architecture, consistent with some embodiments of the present disclosure. As shown in FIG. 3, vector processing unit 141 can comprise a plurality of computation units 300, a plurality of registers 304, decoder 305, loop controller 306, address generator 307, data load unit 308, store unit 309, scalar register 310, etc. Examples of operation codes and instructions that can be used in operating vector processing unit 141 will be explained below only for illustration purposes.

TABLE 1
Exemplary vector operations

| No. | Operation Code | Description |
|---|---|---|
| 1 | vvADD | Load (with stride) two input vectors |
| | | from mem_addr_src1 and |
| | | mem_addr_src2, do element add operation, |
| | | write vector results back to mem_addr_dst |
| 2 | vvSUB | Load (with stride) two input vectors |
| | | from mem_addr_src1 and |
| | | mem_addr_src2, do element sub operation, |
| | | write vector results back to mem_addr_dst |
| 3 | vvMUL | Load (with stride) two input vectors |
| | | from mem_addr_src1 and |
| | | mem_addr_src2, do element mul operation, |
| | | write vector results back to mem_addr_dst |
| 4 | vACCU | Load (with stride) n input vectors |
| | | from mem_addr_src1, do accumulation, |
| | | write results back to mem_addr_dst |
| 5 | vMEAN | Load (with stride) n input vectors |
| | | from mem_addr_src1, do accumulation, |
| | | then multiple by 1/n to get mean value, |
| | | write results back to mem_addr_dst |
| 6 | vMAX | Load (with stride) n input vectors |
| | | from mem_addr_src1, find max of all input, |
| | | write results back to mem_addr_dst |
| 7 | vMIN | Load (with stride) n input vectors |
| | | from mem_addr_src1, find min of all input, |
| | | write results back to mem_addr_dst |
| 8 | vsADD/vsADDi | load scalar from input1 or directly from cmd, |
| | | load vector from mem_addr_src2 (with stride), |
| | | do element add operation, write vector results |
| | | back to mem_addr_dst (with stride) |
| 9 | vsSUB/vsSUBi | load scalar from input1 or directly from cmd, |
| | | load vector from mem_addr_src2 (with stride), |
| | | do element sub operation, write vector results |
| | | back to mem_addr_dst (with stride) |
| 10 | vMUL/vsMULi | load scalar from input1 or directly from cmd, |
| | | load vector from mem_addr_src2 (with stride), |
| | | do element mul operation, write vector results |
| | | back to mem_addr_dst (with stride) |
| 11 | vEXP | Load (with stride) n input vectors from |
| | | mem_addr_src1, do element exp, write n |
| | | results back to mem_addr_dst (with stride) |
| 12 | vTANH | Load (with stride) n input vectors from |
| | | mem_addr_src1, do element tanh, write n |
| | | results back to mem_addr_dst (with stride) |
| 13 | vACCU | Load (with stride) n input vectors from |
| | | mem_addr_src1, for each vector do element |
| | | accumulation, write n scalar results back to |
| | | mem_addr_dst (with stride) |
| 14 | Padding | writing zeros at mem_addr_dst(with stride) |
| 15 | vReSHAPE | read vectors from mem_addr_src1 |
| | | (with stride1), write to |
| | | mem_addr_dst (with stride2) |

Table 1 shows exemplary operation codes representing vector operations that can be performed in vector processing unit 141, consistent with some embodiments of the present disclosure. Table 1 also comprises descriptions about where to obtain data to execute the corresponding operation code and where to store result data after executing the operation code. In Table 1, expressions “mem_addr_src,” “mem_addr_dst,” and “cmd” can represent “source memory address,” “destination memory address,” and “command,” respectively. Further, in Table 1, operation codes 1 to 3 represent vector-vector operations, operation codes 4-7 represent N number of vector operations, operation codes 8-10 represent vector-scalar operations or vector-immediate number operations, operation codes 11-13 represent elementwise vector activation or accumulation operations, operation code 14 represents a vector padding operation, and operation code 15 represents a vector reshaping operation.

TABLE 2
Exemplary instruction set for vector processing unit

| Instruction | Word | | |
|---|---|---|---|
| type | Index | Bit Filed | Explanation |
| vpu_cfg_std | 1 | [1:0] | Specify |
| | | 2′b00: vpu_cfg_std | configuration |
| | | [7:2]: opcode | of vpu |
| | | [8:8]: silent response flag | opcode and |
| | | [31:9]: not used | strides |
| | 2 | [31:0]: stride 1// | |
| | | striede for input 1 | |
| | 3 | [31:0]: stride 2// | |
| | | striede for input 2 | |
| | 4 | [31:0]: stride 3// | |
| | | striede for output | |
| vpu_cfg_loop | 1 | [1:0] | specify |
| | | 2′b01: vpu_cfg_loop | configuration |
| | | [7:2]: opcode | of vpu loop |
| | | [8:8]: silent response flag | number and |
| | | [31:9]: not used | total number |
| | 2 | [31:0]: loopmax1//corresponding | |
| | | to stride1 | |
| | 3 | [31:0]: totaln//total number of | |
| | | vectors to be processed | |
| | 4 | [31:0]: immediate scalar | |
| | | number//for vector | |
| | | immediate scalar operation | |
| vpu_cfg_exc | 1 | [1:0] | specify |
| | | 2′b10: vpu_cfg_exc | configuration |
| | | [7:2]: opcode | of vpu input |
| | | [8:8]: silent response flag | and output |
| | | [31:9]: not used | address |
| | 2 | [31:0]: mem_addr_src1//address | |
| | | for input 1 | |
| | 3 | [31:0]: mem_addr_src2//address | |
| | | for input 2 | |
| | 4 | [31:0]: mem_addr_dst//address | |
| | | for output | |
| vpu_response | 1 | [1:0]: 2′b00: success, | respond vpu |
| | | 2′b01: div-by-0, | status post |
| | | 2′b10: overflow, 2′b11. xxx | process |

Table 2 shows exemplary instructions that can be executed in vector processing unit 141. In some embodiments, vector processing unit 141 can perform tasks according to instructions received from command queue 160. According to some embodiments, one instruction can have a length of four words and each word can have 32 bits. In this example, instruction vpu_cfg_std represents an instruction for configuring strides for inputs. A first word of instruction vpu_cfg_std defines an instruction type, an operation code, etc. For example, last two bits in [1:0] of a first word of a certain instruction can indicate a type of instruction. In this example, the last two bits 00 indicate instruction vpu_cfg_std, the next six bits in [7:2] following the last two bits indicate an operation code for the instruction, and one bit in [8:8] indicates a silent response flag. In some embodiments, when one bit in [8;8] is set to 1, vector processing unit 141 can be instructed not to send out responses, which enables improving overall performance because a host system (or a CPU) does not need to handle responses in-between computation. In this example, 23 upper bits in [31:9] are not used. In instruction vpu_cfg_std, a second word defines a stride for first input data, e.g., attribute data. For example, stride 1 for first input data can define a pattern of first input data, such as a distance between two adjacent rows of input data in memory 150. If a first row, a third row, and a fifth row in memory 150 are used for first input data, stride 1 can be defined as value 2 defining a distance between two adjacent rows. Similarly, a third word can define a stride for second input data and a fourth word can define a stride for output data.

Instruction vpu_cfg_loop represents an instruction for configuring a loop number and a total loop number of vectors to be processed. Similarly, a first word of instruction vpu_cfg_loop defines an instruction type, an operation code, etc. In this example, the last two bits 01 indicate instruction vpu_cfg_loop, the next six bits in [7:2] following the last two bits indicate an operation code for the instruction, and one bit in [8:8] indicates a silent response flag. In this example, 23 upper bits in [31:9] are not used. In instruction vpu_cfg_loop, a second word defines a number of loops corresponding to stride 1 defined in instruction vpu sfg std. In the above example where a first row, a third row, and a fifth row in memory 150 are used for input data 1, a loopmax value can be set as 3. A third word can define a total number of vectors to be processed. For example, when three vectors are used for input data 1 and three vectors are used for input data 2, the third word can be set as 6. In this example, a fourth word can define, if any, an immediate scalar number to be used in the vector operation defined by an operation code in the instruction.

Instruction vpu_cfg_exc represents an instruction for configuring an input and output address for a corresponding operation code. In this example, the last two bits 10 indicate instruction vpu_cfg_exc, the next six bits in [7:2] following the last two bits indicate an operation code for the instruction, and one bit in [8:8] indicates a silent response flag. In this example, 23 upper bits in [31:9] are not used. In instruction vpu_cfg_exc, a second word defines a memory address for input data 1 to be read out from memory 150, a third word defines a memory address for input data 2 to be read out from memory 150, and a fourth word defines a memory address for output data to be stored.

Instruction vpu_response represents an instruction for notifying a vector processing unit status. According to some embodiments, instruction vpu_response can have one word and any information can be included in the instruction. For example, whether an execution has been completed, whether an execution has succeeded or failed, etc. can be included in the instruction. If an execution failed, a reason for failure can also be included in the instruction. For example, last two bits 00 can indicate an execution success, last two bits 01 can indicate a first reason of failure, etc. According to some embodiments, any response or status can be included in instruction vpu_response.

Referring back to FIG. 3, vector processing unit 141 can comprise a plurality of computation units 300 (annotated as PU in FIG. 3). Although two computation units 300 are illustrated in FIG. 3, any number (greater than two) of computation units 300 can be included. For example, vector processing unit 141 can include 8, 16, or 32 processing units. In some embodiments, computation unit 300 can comprise, as indicated by reference number 314, at least one of an accumulation unit, addition unit, subtraction unit, multiplication unit, exponential function (exp) unit, hyperbolic tangent function (Tanh) unit, etc. In some embodiments, a plurality of computation units 300 can have the same architecture as each other. In some embodiments, one computation unit 300 can execute one element of input matrix at one cycle. Therefore, in the example where 32 processing units are included, 32 elements of input vector can be concurrently processed by 32 processing units 300.

According to some embodiments, vector processing unit 141 can further comprise command load unit 316 that can receive a command(s) from command queue 160. An example command is illustrated in FIG. 3 for illustration purposes. Among the received command, an operation code (e.g., indicated as Opcode in FIG. 3) can be decoded in decoder 305 of vector processing unit 141. In some embodiments, decoder 305 can determine tasks to be performed in vector processing unit 141. For example, decoder 305 can receive one of operation codes in Table 1 and determine an operation to be performed in vector processing unit 141. In some embodiments, decoder 305 can further determine which computation unit 300 will be used to process the operation. In some embodiments, decoder 305 can also determine a data load type or a data store type. In some embodiments, decoder 305 can identify whether data to be loaded is a vector, a scalar number, or an immediate number.

Among the received command, strides and a loopmax value can be forwarded to loop controller, consistent with some embodiments of the present disclosure. In some embodiments, loop controller 306 can determine how to read out data from memory 150 based thereon. For example, loop controller 306 can determine a pattern based on a stride value and a repetition number based on a loopmax value for reading out input data or for writing back output data.

The determined information can be forwarded to address generator 307 along with first source address mem_addr_src1 and second source address mem_addr_src2 from command load unit 316, consistent with some embodiments of the present disclosure. In some embodiments, based on the received information, address generator 307 can generate addresses for loading input data 1 and input data 2 from memory 150. In some embodiments, the generated addresses to read out input data can be sent to data load unit 308. In some embodiments, address generator 307 can generate input addresses each cycle. According to some embodiments, destination address mem_addr_dst can be forwarded from command load unit 316 to address generator 307. Address generator 307 can also generate addresses for storing output data into memory 150. In some embodiments, the generated addresses to store output data can be sent to store unit 309.

According to some embodiments, data load unit 308 can communicate with memory 150 to get data at the generated addresses in memory 150. In some embodiments, data load unit 308 can receive load type information determined by decoder 305. Data load unit 308 can forward load type information to selector 303 or corresponding input FIFO (first in first out) registers (e.g., registers 311 and 312), consistent with some embodiments of the present disclosure.

According to some embodiments of the present disclosure, selector 303 of vector processing unit 141 can receive data from memory 150 and determine where to send the received data based on load type information. In some embodiments, selector 303 can be a multiplexer. For example, selector 303 can send vector data of input data 1 to a first FIFO register 311, vector data of input data 2 to a second FIFO register 312, and a scalar number to scalar register 310. In some embodiments, an immediate number can be sent by decoder 305 to scalar register 310.

According to some embodiments, loaded data to first FIFO register 311, second FIFO register 312, and scalar register 310 can be forwarded to computation units 300. In some embodiments, loaded data can be stored in register 304 and can be forwarded to computation units 300. Register 304 will be explained in detail later. In some embodiments, computation unit 300 can have two selectors 301 and 302 and each selector 301 and 302 can determine data to be used for computation based on an operation code. In some embodiments, selectors 301 and 302 each can be a multiplexer. For example, selector 301 can receive data from register 304 and output register 315 of the corresponding computation unit 300, and determine data to be used between the two at a current cycle. Selector 302 can receive data from register 304 and scalar register 310, and determine data to be used between the two at a current cycle. As shown in FIG. 3, computation unit 300 can have two inputs, each of which is selected by selector 301 or selector 302, consistent with some embodiments of the present disclosure.

As shown in FIG. 3, computation unit 300 can comprise output register 315 and a computation result can be temporarily stored in output register 315. In some embodiments, result data stored in output register 315 can be used for computation in a later cycle. According to some embodiments of the present disclosure, result data of computation unit 300 can be forwarded to output FIFO register 313. In some embodiments, each computation unit 300 can have its own output FIFO register 313.

According to some embodiments, store unit 309 in vector processing unit 141 can receive generated addresses for output data to be stored in memory 141. In some embodiments, store unit 309 can also receive store type information from decoder 305. According to some embodiments, store type information can comprise information whether output data is to be stored in register 304 temporarily for a later use or whether output data is to be stored in memory 150. In some embodiments, store unit 309 can share load type information and received address information with memory 150 and output FIFO registers 313. According to some embodiments of the present disclosure, output FIFO registers 313 can forward output data to memory 150 or register 304 based on information received by store unit 309.

As discussed above, vector processing unit 141 can comprise a plurality of registers 304 consistent with some embodiments of the present disclosure. In some embodiments, each computation unit 300 can have its own corresponding register 304. For example, when 32 computation units 300 are included, vector processing unit 141 can have 32 registers 304. In some embodiments, register 304 can have slots for input data for corresponding computation unit 300. In some embodiments, register 304 can have additional slots for temporary data waiting to be used for a later cycle. For example, additional slots can store intermediate result data to be used in a later operation.

In some embodiments, vector processing unit 141 can be configured to load input data for a plurality of computation units 300 parallelly from memory 150 to vector processing unit 141. Similarly, vector processing unit 141 can be configured to store output data from a plurality of computation units 300 parallelly to memory 150. According to some embodiments of the present disclosure, vector processing unit 141 can further comprise status signaling unit 317 to send status signals to response queue 170 to indicate a status of processing a certain instruction or command. For example, a status of decoder 305, data load unit 308, store unit 309, or computation unit 300 can be sent to response queue 170. In some embodiments, vector processing unit 141 can further comprise error handling unit 318 to correct, if any, error(s) based on status signals received by status signaling unit 317. For example, when a status signal from data load unit 308 indicates a certain address generated from address generator 307 is not correct, error handing unit 318 can notify the error to a system to verify and to correct an address.

In some embodiments, a vector operation can be performed in vector processing unit 141 according to a dataflow explained as below. In some embodiments, instructions for vector processing unit 141 can be stored in order in command queue 160. In some embodiments, command queue 160 can be empty and a such signal can also be forwarded to vector processing unit 141. When vector processing unit 141 is ready to process an operation or when vector processing unit 141 is idle, vector processing unit 141 can enable read signal, e.g., read signal cmd_fifo_rd and receive an instruction. The received instruction can be loaded to a command register in command load unit 316. Among received instructions, one instruction can be sent to decoder 305. In some embodiments, decoder 305 can detect an operation code in the instruction and select computation unit(s) 300 to be used for an operation corresponding to the operation code. In some embodiments, command load unit 316 can enable data load to register 304 from addresses defined by first and second source addresses mem_addr_src1 and mem_addr_src2 in memory 150. Based on loaded input data, each computation unit 300 can process an operation corresponding to an operation code in the instruction. Output results from computation units 300 can be stored in corresponding register 304 or in memory 150. According to some embodiments of the present disclosure, when vector processing unit 141 finishes processing of a certain instruction, vector processing unit 141 can send status updates to response queue 170 to indicate completion of a certain instruction.

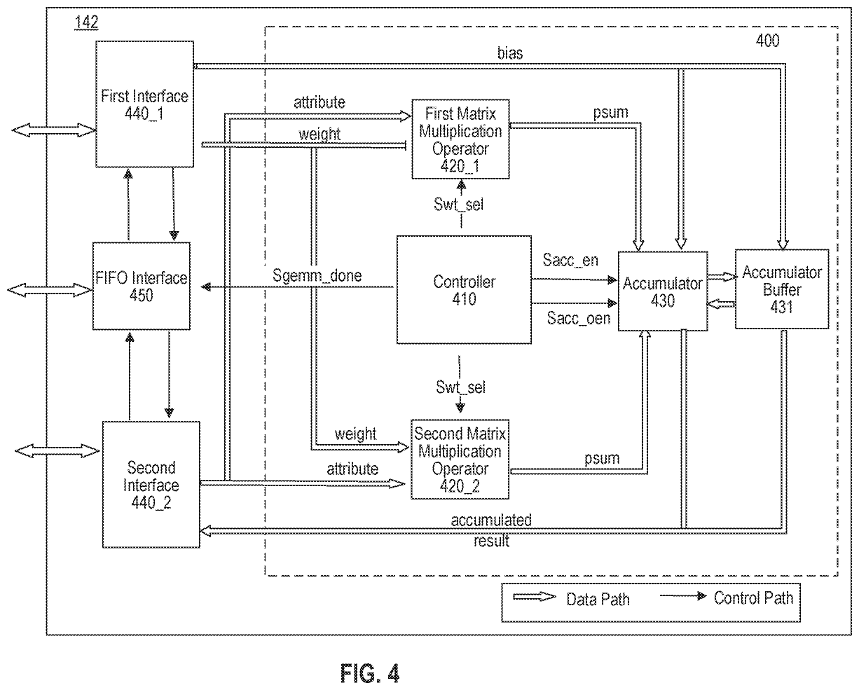

FIG. 4 illustrates an exemplary matrix multiplication unit architecture, consistent with some embodiments of the present disclosure. As shown in FIG. 4, matrix multiplication unit 142 can comprise a controller 410, a matrix multiplication operator 420, and an accumulator 430.

According to some embodiments of the present disclosure, matrix multiplication unit 142 can further comprise an interface 440 to access memory 150. In some embodiments, interface 440 can be an advanced extensible interface (AXI). In some embodiments, interface 440 can comprise a first interface 440_1 and a second interface 440_2. In some embodiments, first interface 440_1 can be configured to access and read out weight data or bias from memory 150. In some embodiments, second interface 440_2 can be configured to access and read out attribute data from memory 150 and to write back output data to memory 150. In some embodiments, first interface 440_1 can be an AXI 0 master and can be configured to connect with an AXI slave for weight data. In some embodiments, second interface 440_2 can be an AXI 1 master and can be configured to connect with an AXI slave for attribute data.

According to some embodiments of the present disclosure, matrix multiplication unit 142 can further comprise a FIFO interface 450 configured to communicate with command queue 160 and response queue 170. In some embodiments, FIFO interface 450 can further be configured to decode matrix multiplication instructions and dispatch command(s) to responsible components in matrix multiplication unit 142. Matrix multiplication instructions that can be used in matrix multiplication unit 142 will be discussed referring to Table 3 only for illustration purposes.

TABLE 3
Exemplary instruction set for matrix multiplication unit 142

| Instruction | Word | | |
|---|---|---|---|
| type | Index | Bit Filed | Explanation |
| gemm_init | 1 | [5:0] | specify |
| | | 5′b00000: gemm_init_weight | information/ |
| | | 5′b00001: gemm_init_attribute | configuration |
| | | 5′b00010: gemm_init_bias | of AXI burst |
| | | 5′b00011: gemm_init_acc | transaction |
| | | [31:6]: not used | |
| | 2 | [15:0]: Burst length, e.g., | |
| | | maximum 8 bits can be used | |
| | | [31:16]: burst size, e.g., | |
| | | 3 bits can used | |
| gemm_rw | 1 | [5:0] | specify start |
| | | 5′b00100: gemm_read_weight | address of |
| | | 5′b00101: gemm_read_attribute | AXI read/write |
| | | 5′b00110: gemm_read_bias | transaction for |
| | | 5′b00111: gemm_write_acc | weight/attribute/ |
| | | [31:6]: not used | bias/accumulated |
| | 2 | [31:0]: start address | result |
| gemm_start | 1 | [5:0] | Initiate |
| | | 5′b1xxxx: | GEMM |
| | | bit[0]: partial, partial result | operation |
| | | will not be written back, | |
| | | store in accumulator buffer | |
| | | bit[1]: clear, clear accumulator | |
| | | buffer when set | |
| | | bit[2]: relu, initiate ReLu | |
| | | operation to the accumulated | |
| | | result when set | |
| | | bit[3]: bias, load bias when set | |
| | | [31:6]: not used | |
| | 2 | [31:0]: total blocks to be | |
| | | computed | |
| gemm_finish | 1 | [0] | indicate end |
| | | 1′b1: finish | of one GEMM |
| | | | operation |

Table 3 shows exemplary instructions that can be executed in matrix multiplication unit 142. In some embodiments, matrix multiplication unit 142 can perform tasks according to instructions received from command queue 160. According to some embodiments, one instruction can have a length of two words and each word can have 32 bits. In this example, instruction gemm_init represents an instruction specifying information or configuration of AXI burst transactions. A first word of instruction gemm_init defines an instruction type, an operation code, etc. For example, last five bits in [5:0] of first word of a certain instruction can indicate a type of an instruction and an operation code. In this example, last five bits 00000 indicate instruction gemm_init_weight, which instructs to prepare for loading weight data from memory 150. Similarly, last five bits 00001 indicate instruction gemm_init_attribute, which instructs to prepare for loading attribute data from memory 150. Last five bits 00010 can indicate instruction gemm_init_bias, which instructs to prepare for loading bias data and last five bits 00011 indicate instruction gemm_init_acc, which instructs to prepare for storing accumulation result data to memory 150. As a preparation, matrix multiplication unit 142 can configure register(s) on matrix multiplication unit 142 for loading data, or matrix multiplication unit 142 can notify a coresponding memory device to prepare for storing data from matrix multiplication unit 142. In this example, 26 upper bits in [31:6] are not used. In instruction gemm_init, a second word defines a burst length in [15:0] and a burst size in [31:16] for loading data at the same time or for storing data at the same time. In some embodiments, 8 bits can be used for a burst length and 3 bits can be used for a burst size.

Instruction gemm_rw can represent an instruction specifying a start address of AXI read/write transaction for weight data, attribute data, bias data, or accumulation result data. A first word of instruction gemm_rw defines an instruction type, an operation code, etc. In this example, last five bits 00100 indicate instruction gemm_read_weight, which instructs to read out weight data from memory 150. Similarly, last five bits 00101 indicate instruction gemm_read_attribute, which instructs to read out attribute data from memory 150. Last five bits 00110 can indicate instruction gemm_read_bias, which instructs to read out bias data and last five bits 00111 indicate instruction gemm_read_acc, which instructs to write accumulation result data to memory 150. In this example, 26 upper bits in [31:6] are not used. In instruction gemm_rw, a second word defines a starting address in [31:0] for reading out data or writing data.

Instruction gemm_start can represent an instruction initiating a matrix multiplication operation. A first word of instruction gemm_start defines an instruction type, an operation code, etc. In this example, last five bits 1xxxx can indicate an operation code, which instructs to start processing a matrix multiplication operation. In this example, bit[0] can define information to store a partial result in an accumulator buffer without writing back to memory 150. Similarly, bit[1] can define information to clear an accumulator buffer when set (e.g., bit[1] is set to 1), bit[2] can define information to initiate a ReLu operation to an accumulation result when set, and bit [3] can define information to load bias when set. In this example, 26 upper bits in [31:6] are not used. In instruction gemm_start, a second word defines a total block number to be computed on matrix multiplication unit 142.

Instruction gemm_finish represents an instruction of indicating end of one matrix multiplication operation. According to some embodiments, instruction gemm_finish can have one word and any information regarding an execution result can be included in the instruction. For example, the last one bit can represent that an execution has been completed. In some embodiments, whether an execution has succeeded or failed, etc. can also be included in the instruction. If an execution failed, a reason for failure can also be included in the instruction. According to some embodiments, any response or status can be included in instruction gemm_finish.

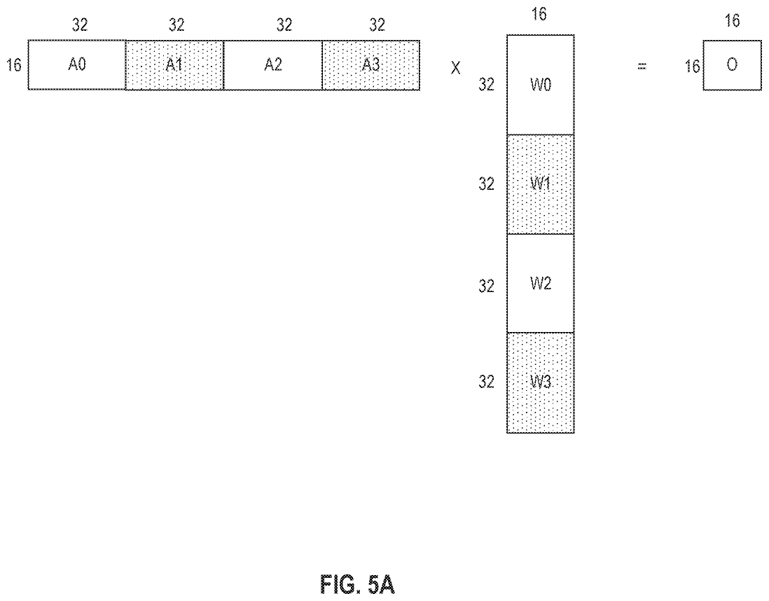

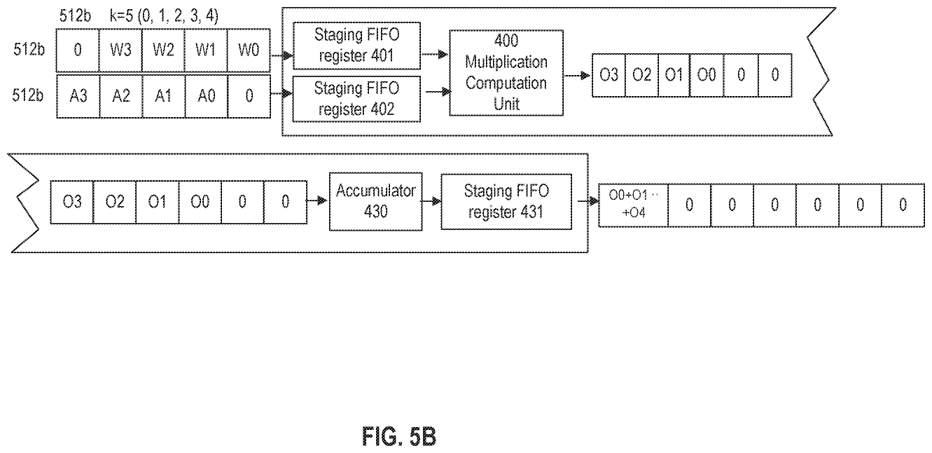

Referring back to FIG. 4, matrix multiplication operator 420 can comprise a plurality of matrix multiplication operators 420_1 and 420_2. In some embodiments, matrix multiplication operator 420 can be implemented as a systolic array. In some embodiments, a plurality of matrix multiplication operators 420_1 and 420_2 can operate parallelly in a pipelined manner. While two multiplication operators 420_1 and 420_2 are illustrated in FIG. 4, it will be appreciated that any number of matrix multiplication operators can be used in some embodiments of the present disclosure. Functions and operations of matrix multiplication operator 420 will be explained in detail referring to FIG. 5A and FIG. 5B.

According to some embodiments of the present disclosure, accumulator 430 can accumulate results received from a plurality of matrix multiplication operators 420. In some embodiments, controller 410 can be configured to control matrix multiplication unit 142 in processing instructions in matrix multiplication unit 142 according to a dataflow, which will be explained referring to FIG. 5B. In some embodiments, as shown in FIG. 4, controller 410 can send control signals Sacc_en and Sacc_oen to enable or disable accumulator 430. In some embodiments, controller 410 can send control signal Swt_sel to notify matrix multiplication operator 420 of weight data to be loaded. In some embodiments, controller 410 can send control signal Sgemm_done to notify FIFO interface 450 of completion of a matrix multiplication operation.

FIG. 5A shows an example matrix multiplication operation, which will be used when explaining a data flow in matrix multiplication unit 142 for illustration purposes. As shown in FIG. 5A, a matrix multiplication operation is to calculate matrix multiplication between attribute matrix A and weight matrix W and to generate output data O. In this example, attribute matrix A comprises four blocks A0 to A3, each block has a size of 16×32 and weight matrix W comprises four blocks W0 to W3, each block has a size of 32×16. As a result, output data O has a size of 16×16. In this example, a matrix multiplication operation shown in FIG. 5A can be a first matrix multiplication operation of one matrix multiplication operation of matrix multiplication between the attribute matrix A and a weight matrix half of which corresponds to the weight matrix W. Therefore, in order to finish the whole matrix multiplication operation, a first operation shown in FIG. 5A and a second operation for the last half matrix of the weight matrix can be performed. Here, the last half matrix of the weight matrix can have the same size as the weight matrix W.

In some embodiments, matrix multiplication unit 142 can compute matrix multiplication of matrix 1 of size (N, k*(2*N)) and matrix 2 of size (k*(2*N), N). Here, N is a design related parameter and can be determined depending on a hardware size (e.g., a dimension size of matrix multiplication operator 420) implemented on matrix multiplication unit 142, and k is a workload parameter (e.g., input data size for a certain operation) and can be obtained from matrix multiplication instructions. According to a number of matrix multiplication operators 420 implemented in the hardware, the component 2*N in the matrix size (e.g., (N, k*(2*N)) or (k*(2*N), N)) can be set to as 2ⁿ*N. Here, an index n can be a number of pairs of matrix multiplication operators (e.g., systolic arrays) implemented in the hardware. In an example where two matrix multiplication operators 420_1 and 420_2 as illustrated in FIG. 4, index n equals to 1.

FIG. 5B illustrates an example data flow timing in matrix multiplication unit 142 for processing a first matrix multiplication operation of FIG. 5A, consistent with some embodiments of the present disclosure. According to some embodiments, a matrix multiplication instruction can be stored in order in command queue 160. In some embodiments, command queue 160 can be empty and such signal can also be forwarded to matrix multiplication unit 142. In some embodiments, when matrix multiplication unit 142 is ready to process an operation or when matrix multiplication unit 142 is idle, matrix multiplication unit 142 can enable, through controller 410 and FIFO interface 450, signal Scmd fifo_rd to get instruction(s) from command queue 160. After receiving the instruction, FIFO interface 450 can decode an operation code and the decoded information can be stored in an internal register (not shown) on matrix multiplication unit 142 consistent with some embodiments of the present disclosure. If instruction gemm_start is received, receiving a new instruction can be suspended according to some embodiments of the present disclosure. In some embodiments, from multiplication operation instruction(s), matrix multiplication unit 142 may have information that is used for processing a corresponding matrix multiplication operation. In this example, instruction gemm_start can be an instruction to perform the whole matrix multiplication operation including a first matrix multiplication operation shown in FIG. 5A and a second matrix multiplication operation. In some embodiments, a first matrix multiplication operation can be processed first and then a second matrix multiplication operation can be processed.

According to some embodiments of the present disclosure, to process a first matrix multiplication operation, data transfer can be performed first. When a first matrix multiplication operation uses bias data, reading bias data from memory 150 can be started according to some embodiments of the present disclosure. In some embodiments, information of an address, a burst length, and a burst size for loading data can be obtained from matrix multiplication instruction(s). In some embodiments, bias data read from memory 150 can be stored in each row of an accumulator buffer 431. After finishing of loading bias data, first interface 440_1 can start loading of weight data from memory 150 according to some embodiments of the present disclosure. Similarly, second interface 440_2 can start loading attribute data one block later than weight data. In some embodiments where bias data is not used, first interface 440_1 can start reading weight data and, one block later, second interface 440_2 can start reading attribute data.

Referring back to FIG. 4 and FIG. 5B, according to some embodiments of the present disclosure, weight matrix W and attribute matrix A can be loaded to matrix multiplication unit 142 for matrix multiplication. In some embodiments, first weight block W0 of weight matrix W can be loaded to matrix multiplication unit 142, e.g., via a staging FIFO register 401 and then one block later first attribute block A0 of attribute matrix A can be loaded to matrix multiplication unit 142, e.g., via a staging FIFO register 402. In some embodiments, in a first cycle, first weight block W0 can be loaded to first matrix multiplication operator 420_1 (e.g., systolic array) on matrix multiplication unit 142 in FIG. 4 and, in a second cycle, first attribute block A0 can be loaded to first matrix multiplication operator 420. In a third cycle, first matrix multiplication operator 420 can compute matrix multiplication between first weight block W0 and first attribute block A0, and first output block O0 can be generated.

In the meantime, second multiplication operator 420_2 on matrix multiplication unit 142 can compute matrix multiplication between second weight block W1 and second attribute block A1. In the second cycle, while first attribute block A0 is loaded via second interface 440_2, second weight block W1 can be loaded to second matrix multiplication operator 440_2 via first interface 440_1. Similarly, in the third cycle, while first matrix multiplication operator 420_1 is in computation, second attribute block A1 is loaded to second matrix multiplication operator 420_2 via second interface 440_2. In a fourth cycle, second matrix multiplication operator 420_2 can compute matrix multiplication between second weight block W1 and second attribute block A1, and second output block O1 can be generated.

Similarly, in a fifth cycle, first matrix multiplication operator 420_1 can compute matrix multiplication between third weight block W2 and third attribute block A2, and third output block O2 can be generated. Similarly, fourth output block O3 can be generated by second matrix multiplication operator 420_2 in a sixth cycle. As explained above, according to some embodiments of the present disclosure, matrix multiplication unit 142 enables processing matrix multiplication operations sequentially and parallelly in a pipelined manner without wasting resources. In some embodiments, matrix multiplication unit 142 can use ping-pong buffers for storing weight data so that weight data switching can be pipelined without interrupting pipelined execution of a matrix multiplication operation.

According to some embodiments of the present disclosure, output results of matrix multiplication operator 420 can be sent to accumulator 430 sequentially in the order of being generated. In the example above, first output block O0 to fourth output block O3 can be sent to accumulator 430 from a third cycle to a sixth cycle. In some embodiments, accumulator 430 can start accumulating received output blocks. For example, first output block O0 and second output block O1 are sent to accumulator 430 in a third cycle and a fourth cycle, respectively, and accumulator 430 can perform accumulation between first output block O0 and second output block O1 in a fourth cycle. Similarly, in a fifth cycle, accumulator 430 can perform accumulation between third output block O2 and a partial output block, which is summation of first output block O0 and second output block O1. Similarly, in a sixth cycle, accumulator 430 can perform accumulation between fourth output block O3 and a partial output block, which is summation of first output block O0, second output block O1, and third output block O2, and final output block O can be generated. In some embodiments where bias data is stored in accumulator buffer 431, bias data can be added to final output block O. In some embodiments, an output staging FIFO register 431 of accumulator 430 can delay accumulation output by one block further to ensure processing of a matrix multiplication operation correctly in parallel on matrix multiplication unit 142. For example, the final output block O of accumulator 430 can be outputted in a seventh cycle as shown in FIG. 5B.

According to some embodiments of the present disclosure, when an output result from accumulator 430 is a partial result, second interface 440_2 may not start writing back the output result into memory 150 but the output result can be stored in accumulator buffer 431. In the above example, the partial output blocks generated in a fifth cycle and a sixth cycle are not written back to memory 150 but are stored in accumulator buffer 431 for later use. According to some embodiments, when an output result from accumulator 430 is not a partial result but is a final result for a corresponding accumulation operation, second interface 440_2 can start writing the output result back to memory 150 and accumulator buffer 431 is cleared after completion of writing back. In this example, final output block O generated in a seventh cycle can be written back to memory 150 and accumulator buffer 431 can be cleared.

According to some embodiments of the present disclosure, after completion of a first matrix multiplication operation, a process of a second matrix multiplication operation can be initiated automatically. In some embodiments, a second matrix multiplication operation can use the same attribute data and, if any, bias data with those of a first matrix multiplication operation shown in FIG. 5B and can use a different set of weight data. In this example, a process of computing a second matrix multiplication operation can be similar to that of a first matrix multiplication operation illustrated above. It will be noted that bias data is not required to be loaded because the same bias data as that of a first matrix multiplication operation can be used for a second matrix multiplication operation and the bias data was loaded already in accumulator buffer 431 to process a first matrix multiplication operation. In this example, an address for a new set of weight data can have a stride value, which can represent a distance from a first set of weight data for a first matrix multiplication operation. An address of attribute data to be loaded and an address for output data to be stored can remain unchanged from those of a first matrix multiplication operation.

According to some embodiments of the present disclosure, after matrix multiplication unit 142 finishes processing of a second matrix multiplication operation, operation result data can be written back to memory 150, and matrix multiplication unit 142 can send a status update to response queue 170 to indicate the certain operation's completion.

According to some embodiments, when matrix multiplication unit 142 is ready to process an operation or when matrix multiplication unit 142 is idle, a data process similar to processing a first matrix multiplication operation and a second matrix multiplication operation as explained above can be repeated. In some embodiments, such matrix multiplication operation can be repeated.

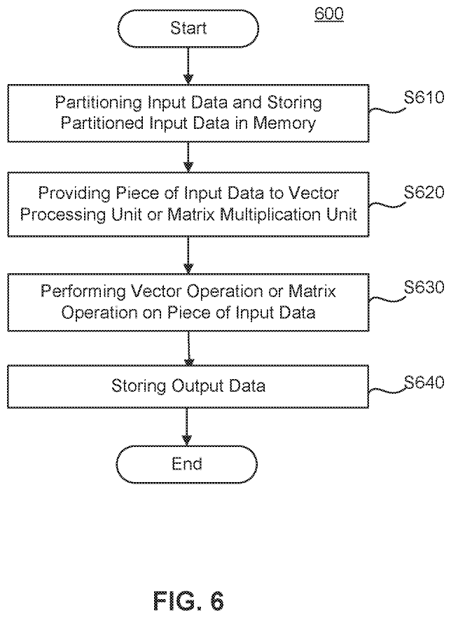

FIG. 6 illustrates an exemplary method for processing a vector operation or matrix operation, consistent with some embodiments of the present disclosure. The steps of method 600 can be performed by a neural network accelerator (e.g., neural network accelerator 100 of FIG. 1A) or can be performed at least in part on a neural network accelerator core (e.g., vector accelerating unit 140 of FIG. 1B). For illustrative purposes, a method for processing vector operation or matrix operation will be described referring to vector accelerating unit 140 of FIG. 1B.

In step S610, input data can be partitioned and stored in memory (e.g., memory 150 of FIG. 1B). In some embodiments, input data can be partitioned into multiple pieces of data and each piece of data can be stored in a corresponding row of a plurality of rows of memory 150. In some embodiments, each row of the plurality of rows of memory 150 can have a size that can be processed concurrently by a plurality of computation units of vector processing unit 141 or by matrix multiplication unit 142. Input data partitioning and storing has been described referring to FIG. 2, and thus the detailed explanation thereof will be omitted here for simplicity purposes.

In step S620, a piece of data stored in memory is provided to a vector processing unit or a matrix multiplication unit. In some embodiments, a piece of data provided to vector processing unit 141 can be a piece of data stored in one row of plurality of rows in memory 150. In some embodiments, a piece of data provided to matrix multiplication unit 142 can be a block of data stored in one or more rows of plurality of rows in memory 150.

In step S630, a vector operation or multiplication operation is performed on the piece of data provided in step S620. In some embodiments, a vector operation can be performed on the piece of data by vector processing unit 141. In some embodiments, another piece of data stored in another row in memory 150 can be provided to vector processing unit 141, and a vector operation can be performed based on the two pieces of data by vector processing unit 141. In some embodiments, a matrix operation can be performed on the piece of data by matrix multiplication unit 142. In some embodiments, the piece of data can be attribute data, bias data, or weight data for performing a matrix multiplication operation. Vector operation performed by vector processing unit 141 and matrix multiplication operation performed by matrix multiplication unit 142 have been described referring to FIG. 3 to FIG. 5B and thus the detailed explanation thereof will be omitted here for simplicity purposes.

In step S640, output data of a vector operation or matrix operation can be stored. In some embodiments, output data of a vector operation or a matrix multiplication operation can be stored in memory 150. In some embodiments where output data of a vector operation or a matrix multiplication operation is an intermedia result, the output data can be stored in register 304 on vector processing unit 141 or accumulator buffer 431 on matrix multiplication unit 142. In some embodiments, output data of a vector operation can be an output vector, and the output vector can be stored in one row of plurality of rows in memory 150. In some embodiments, output data of a matrix multiplication operation can be an output matrix, and the output matrix can be stored in one or more rows of plurality of rows in memory 150. In some embodiments, output data stored in memory 150 can be accessed by vector processing unit 141 or matrix multiplication unit 142 for later use.

The embodiments may further be described using the following clauses:

1. An accelerator for processing a vector or matrix operation, comprising:

a vector processing unit comprising a plurality of computation units having circuitry configured to process a vector operation in parallel;

a matrix multiplication unit comprising a first matrix multiplication operator, a second matrix multiplication operator, and an accumulator, the first matrix multiplication operator and the second matrix multiplication operator having circuitry configured to process a matrix operation and the accumulator having circuitry configured to accumulate output results of the first matrix multiplication operator and the second matrix multiplication operator; and

a memory storing input data for the vector operation or the matrix operation and being configured to communicate with the vector processing unit and the matrix multiplication unit.

2. The accelerator of clause 1, wherein each of the plurality of computation units having circuitry configured to process an elementwise computation of the vector operation in parallel.

3. The accelerator of clause 1 or 2, wherein the plurality of computation units have a same architecture as each other.

4. The accelerator of any one of clauses 1-3, wherein the vector processing unit further comprises a plurality of registers corresponding to the plurality of computation units, respectively.

5. The accelerator of any one of clauses 1-4, wherein output data of the vector processing unit or the matrix multiplication unit is stored in the memory and the vector processing unit or the matrix multiplication unit is configured to access the memory to use the output data.

6. The accelerator of any one of clauses 1-5, wherein the memory comprises a plurality of rows, each row being configured to store data that can be processed concurrently by the plurality of computation units.

7. The accelerator of clause 6, wherein the input data is partitioned into multiple pieces of data and each piece of data is stored in a corresponding row of the plurality of rows.

8. The accelerator of any one of clauses 1-5, wherein the first matrix multiplication operator and the second matrix multiplication operator are systolic arrays.

9. The accelerator of any one of clauses 1-8, wherein the input data comprises a weight matrix and an attribute matrix, and the first matrix operator is configured to compute first matrix multiplication between a first weight block of the weight matrix and a first attribute block of the attribute matrix after the first weight block and the first attribute block are loaded to the first matrix multiplication operator, the first attribute block being loaded after the first weight block is loaded.

10. The accelerator of clause 9, wherein the second matrix multiplication operator is configured to compute second matrix multiplication between a second weight block of the weight matrix and a second attribute block of the attribute matrix after the first matrix multiplication operator completes computation of the first matrix multiplication, and wherein the second weight block is loaded while the first attribute block is loaded to the first matrix multiplication operator and the second attribute block is loaded while the first matrix operator computes the first matrix multiplication.

11. The accelerator of clause 10, wherein the accumulator is configured to:

acquire sequentially a first result of the first matrix multiplication and a second result of the second matrix multiplication; and

compute summation of the first result and the second result and generates an accumulation result.

12. The accelerator of clause 11, wherein the accumulator comprises an accumulator buffer configured to store the accumulation result when the accumulation result is a partial result.

13. The accelerator of clause 12, wherein the input data further comprises bias data and the bias data is loaded to the accumulator buffer before the first weight block is loaded to the first matrix multiplication operator.

14. The accelerator of any one of clauses 9-13, wherein the matrix multiplication unit further comprises a first interface and a second interface, the first interface being configured to load the weight matrix and the second interface being configured to load the attribute matrix.

15. The accelerator of any one of clauses 9-14, wherein the matrix multiplication unit further comprises ping-pong buffers for the weight matrix.

16. The accelerator of any one of clauses 9-15, wherein the memory comprises a plurality of rows, each row having a same size as a row of the first attribute block.

17. A method for processing a vector or matrix operation on an accelerator comprising a vector processing unit comprising a plurality of computation units having circuitry configured to process a vector operation in parallel, a matrix multiplication unit comprising a matrix multiplication operator having circuitry configured to process a matrix operation, and a memory storing input data for the vector operation or the matrix operation and comprising a plurality of rows, each row being configured to store data that can be processed concurrently by the plurality of computation units or by the matrix multiplication operator, the method comprising:

partitioning input data into multiple pieces of data and storing each piece of data in a corresponding row of the plurality of rows;

providing a first piece of data stored in a first row of the plurality of rows to the vector processing unit or the matrix multiplication unit; and

performing a vector operation or a matrix operation on the first piece of data concurrently by the plurality of computation units or by the matrix multiplication operator.

18. The method of clause 17, further comprising:
providing a second piece of data stored in a second row of the plurality of rows to the vector processing unit; and
wherein performing the vector operation comprises performing the vector operation on the first piece of data and the second piece of data concurrently by the plurality of computation units.

19. The method of clause 17 or 18, wherein performing the vector operation comprises processing an elementwise computation of the vector operation in parallel by the plurality of computation units.

20. The method of any one of clauses 17-19, further comprising:

storing an output vector of the vector processing unit in a third row of the plurality of rows.

21. The method of clause 17, wherein the input data comprises a weight matrix and an attribute matrix, and the matrix multiplication operator comprises a first matrix multiplication operator and a second matrix multiplication operator, and

wherein providing the first piece of data comprises:
providing a first weight block of the weight matrix to the first matrix multiplication operator, the first weight block comprises the first piece of data;
providing a first attribute block of the attribute matrix to the first matrix multiplication operator; and

wherein performing the vector operation comprises performing first matrix multiplication between the first weight block and the first attribute block by the first matrix multiplication operator.

22. The method of clause 21, further comprising:

providing a second weight block of the weight matrix to the second matrix multiplication operator while the first attribute block is being provided to the first matrix multiplication operator;

providing a second attribute block of the attribute matrix to the second matrix multiplication operator while the first matrix multiplication is being performed by the first matrix multiplication operator; and

performing second matrix multiplication between the second weight block and the second attribute block by the second matrix multiplication operator.

23. The method of clause 22, wherein the matrix multiplication unit further comprises an accumulator, and

the method further comprising:
providing to the accumulator sequentially a first result of the first matrix multiplication and a second result of the second matrix multiplication; and
performing summation of the first result and the second result and generates an accumulation result.

24. The method of clause 23, wherein the accumulator comprises an accumulator buffer,

the method further comprising:
storing the accumulation result in the accumulator buffer when the accumulation result is a partial result.

25. The method of clause 24, wherein the input data further comprises bias data,

the method further comprising:

providing the bias data to the accumulator buffer before the first weight block is provided to the first matrix multiplication operator.

26. The method of clause 23, further comprising:

storing the accumulation result in the memory.

27. A non-transitory computer readable medium that stores a set of instructions that is executable by at least one processor of a computing device to cause the computing device to perform a method for processing a vector or matrix operation on the computing device comprising a vector processing unit comprising a plurality of computation units having circuitry configured to process a vector operation in parallel, a matrix multiplication unit comprising a matrix multiplication operator having circuitry configured to process a matrix operation, and a memory storing input data for the vector operation or the matrix operation and comprising a plurality of rows, each row being configured to store data that can be processed concurrently by the plurality of computation units or by the matrix multiplication operator, the method comprising:

partitioning input data into multiple pieces of data and storing each piece of data in a corresponding row of the plurality of rows;

providing a first piece of data stored in a first row of the plurality of rows to the vector processing unit or the matrix multiplication unit; and

performing a vector operation or a matrix operation on the first piece of data concurrently by the plurality of computation units or by the matrix multiplication operator.

28. The computer readable storage medium of clause 27, wherein the set of instructions that is executable by at least one processor of the computing device to cause the computing device to further perform:

providing a second piece of data stored in a second row of the plurality of rows to the vector processing unit; and

performing the vector operation on the first piece of data and the second piece of data concurrently by the plurality of computation units.

29. The computer readable storage medium of clause 27 or 28, wherein performing the vector operation comprises processing an elementwise computation of the vector operation in parallel by the plurality of computation units.

30. The computer readable storage medium of any one of clauses 27-29, wherein the set of instructions that is executable by at least one processor of the computing device to cause the computing device to further perform:

storing an output vector of the vector processing unit in a third row of the plurality of rows.

31. The computer readable storage medium of clause 27, wherein the input data comprises a weight matrix and an attribute matrix, and the matrix multiplication operator comprises a first matrix multiplication operator and a second matrix multiplication operator, and

wherein the set of instructions that is executable by at least one processor of the computing device to cause the computing device to further perform:

providing a first weight block of the weight matrix to the first matrix multiplication operator, the first weight block comprises the first piece of data;

providing a first attribute block of the attribute matrix to the first matrix multiplication operator; and

performing first matrix multiplication between the first weight block and the first attribute block by the first matrix multiplication operator.

32. The computer readable storage medium of clause 31, wherein the set of instructions that is executable by at least one processor of the computing device to cause the computing device to further perform:

providing a second weight block of the weight matrix to the second matrix multiplication operator while the first attribute block is being provided to the first matrix multiplication operator;

providing a second attribute block of the attribute matrix to the second matrix multiplication operator while the first matrix multiplication is being performed by the first matrix multiplication operator; and

performing second matrix multiplication between the second weight block and the second attribute block by the second matrix multiplication operator.

33. The computer readable storage medium of clause 32, wherein the matrix multiplication unit further comprises an accumulator, and

wherein the set of instructions that is executable by at least one processor of the computing device to cause the computing device to further perform:

providing to the accumulator sequentially a first result of the first matrix multiplication and a second result of the second matrix multiplication; and

performing summation of the first result and the second result and generates an accumulation result.

34. The computer readable storage medium of clause 33, wherein the accumulator comprises an accumulator buffer, and

wherein the set of instructions that is executable by at least one processor of the computing device to cause the computing device to further perform:
storing the accumulation result in the accumulator buffer when the accumulation result is a partial result.

35. The computer readable storage medium of clause 34, wherein the input data further comprises bias data, and

wherein the set of instructions that is executable by at least one processor of the computing device to cause the computing device to further perform:

providing the bias data to the accumulator buffer before the first weight block is provided to the first matrix multiplication operator.

36. The computer readable storage medium of clause 33, wherein the set of instructions that is executable by at least one processor of the computing device to cause the computing device to further perform:

storing the accumulation result in the memory.

37. A device, comprising:

a host unit; and

an accelerator communicatively coupled to the host unit, the accelerator comprising:
a vector processing unit comprising a plurality of computation units having circuitry configured to process a vector operation in parallel;
a matrix multiplication unit comprising a first matrix multiplication operator, a second matrix multiplication operator, and an accumulator, the first matrix multiplication operator and the second matrix multiplication operator having circuitry configured to process a matrix operation and the accumulator having circuitry configured to accumulate output results of the first matrix multiplication operator and the second matrix multiplication operator; and
a memory storing input data for the vector operation or the matrix operation and being configured to communicate with the vector processing unit and the matrix multiplication unit.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. An accelerator for processing a vector or matrix operation, comprising:
a vector processing unit comprising a plurality of computation units having circuitry configured to process a vector operation in parallel;
a matrix multiplication unit comprising a first matrix multiplication operator, a second matrix multiplication operator, and an accumulator, the first matrix multiplication operator and the second matrix multiplication operator having circuitry configured to process a matrix operation and the accumulator having circuitry configured to accumulate output results of the first matrix multiplication operator and the second matrix multiplication operator; and
a memory storing input data for the vector operation or the matrix operation and being configured to communicate with the vector processing unit and the matrix multiplication unit.

2. The accelerator of claim 1, wherein each of the plurality of computation units having circuitry configured to process an elementwise computation of the vector operation in parallel.

3. The accelerator of claim 1, wherein the plurality of computation units have a same architecture as each other.

4. The accelerator of claim 1, wherein output data of the vector processing unit or the matrix multiplication unit is stored in the memory and the vector processing unit or the matrix multiplication unit is configured to access the memory to use the output data.

5. The accelerator of claim 1, wherein the memory comprises a plurality of rows, each row being configured to store data that can be processed concurrently by the plurality of computation units.

6. The accelerator of claim 5, wherein the input data is partitioned into multiple pieces of data and each piece of data is stored in a corresponding row of the plurality of rows.

7. The accelerator of claim 1, wherein the input data comprises a weight matrix and an attribute matrix, and the first matrix operator is configured to compute first matrix multiplication between a first weight block of the weight matrix and a first attribute block of the attribute matrix after the first weight block and the first attribute block are loaded to the first matrix multiplication operator, the first attribute block being loaded after the first weight block is loaded.

8. The accelerator of claim 7, wherein the second matrix multiplication operator is configured to compute second matrix multiplication between a second weight block of the weight matrix and a second attribute block of the attribute matrix after the first matrix multiplication operator completes computation of the first matrix multiplication, and wherein the second weight block is loaded while the first attribute block is loaded to the first matrix multiplication operator and the second attribute block is loaded while the first matrix operator computes the first matrix multiplication.

9. The accelerator of claim 8, wherein the accumulator is configured to:
acquire sequentially a first result of the first matrix multiplication and a second result of the second matrix multiplication; and
compute summation of the first result and the second result and generates an accumulation result.

10. The accelerator of claim 9, wherein the accumulator comprises an accumulator buffer configured to store the accumulation result when the accumulation result is a partial result.

11. The accelerator of claim 10, wherein the input data further comprises bias data and the bias data is loaded to the accumulator buffer before the first weight block is loaded to the first matrix multiplication operator.

12. The accelerator of claim 7, wherein the matrix multiplication unit further comprises a first interface and a second interface, the first interface being configured to load the weight matrix and the second interface being configured to load the attribute matrix.

13. The accelerator of claim 7, wherein the memory comprises a plurality of rows, each row having a same size as a row of the first attribute block.

14. A method for processing a vector or matrix operation on an accelerator comprising a vector processing unit comprising a plurality of computation units having circuitry configured to process a vector operation in parallel, a matrix multiplication unit comprising a matrix multiplication operator having circuitry configured to process a matrix operation, and a memory storing input data for the vector operation or the matrix operation and comprising a plurality of rows, each row being configured to store data that can be processed concurrently by the plurality of computation units or by the matrix multiplication operator, the method comprising:
partitioning input data into multiple pieces of data and storing each piece of data in a corresponding row of the plurality of rows;
providing a first piece of data stored in a first row of the plurality of rows to the vector processing unit or the matrix multiplication unit; and
performing a vector operation or a matrix operation on the first piece of data concurrently by the plurality of computation units or by the matrix multiplication operator.

15. The method of claim 14, further comprising:
providing a second piece of data stored in a second row of the plurality of rows to the vector processing unit; and
wherein performing the vector operation comprises performing the vector operation on the first piece of data and the second piece of data concurrently by the plurality of computation units.

16. The method of claim 14, wherein performing the vector operation comprises processing an elementwise computation of the vector operation in parallel by the plurality of computation units.

17. The method of claim 14, wherein the input data comprises a weight matrix and an attribute matrix, and the matrix multiplication operator comprises a first matrix multiplication operator and a second matrix multiplication operator, and
wherein providing the first piece of data comprises:
providing a first weight block of the weight matrix to the first matrix multiplication operator, the first weight block comprises the first piece of data;
providing a first attribute block of the attribute matrix to the first matrix multiplication operator; and
wherein performing the vector operation comprises performing first matrix multiplication between the first weight block and the first attribute block by the first matrix multiplication operator.

18. The method of claim 17, further comprising:
providing a second weight block of the weight matrix to the second matrix multiplication operator while the first attribute block is being provided to the first matrix multiplication operator;
providing a second attribute block of the attribute matrix to the second matrix multiplication operator while the first matrix multiplication is being performed by the first matrix multiplication operator; and
performing second matrix multiplication between the second weight block and the second attribute block by the second matrix multiplication operator.

19. The method of claim 18, wherein the matrix multiplication unit further comprises an accumulator, and
the method further comprising:
providing to the accumulator sequentially a first result of the first matrix multiplication and a second result of the second matrix multiplication; and
performing summation of the first result and the second result and generates an accumulation result.

20. A device, comprising:
a host unit; and
an accelerator communicatively coupled to the host unit, the accelerator comprising:
a vector processing unit comprising a plurality of computation units having circuitry configured to process a vector operation in parallel;
a matrix multiplication unit comprising a first matrix multiplication operator, a second matrix multiplication operator, and an accumulator, the first matrix multiplication operator and the second matrix multiplication operator having circuitry configured to process a matrix operation and the accumulator having circuitry configured to accumulate output results of the first matrix multiplication operator and the second matrix multiplication operator; and
a memory storing input data for the vector operation or the matrix operation and being configured to communicate with the vector processing unit and the matrix multiplication unit.
